(19) United States
(12) Patent Application Publication
(10) Pub. No.: US 2013/0191477 A1
(43) Pub. Date: Jul. 25, 2013

(54) MAPPING SYSTEM, NETWORK, AND METHOD FOR ADAPTATION OF ID/LOC SEPARATION TO DATACENTER FOR CLOUD COMPUTING

(71) Applicant: Electronics and Telecommunications Research Institute, Daejeon (KR)

(72) Inventors: Tae Wan YOU, Daejeon (KR); Hee Young JUNG, Daejeon (KR)

(73) Assignee: Electronics and Telecommunications Research Institute, Daejeon (KR)

(21) Appl. No.: 13/745,065

(22) Filed: Jan. 18, 2013

(30) Foreign Application Priority Data
Jan. 20, 2012 (KR) 10-2012-0006498

(51) Int. Cl. H04L 12/58

(52) U.S. Cl. CPC H04L 51/00
USPC 709/206

(57) ABSTRACT

Provided is a mapping system, a network, and a method for adaptation of identifier (ID)/locator (LOC) separation to a cloud datacenter. A cloud datacenter environment may be divided into layers hierarchically for adaptation to ID/LOC separation, an ID may be defined for each layer, and a networking service may be provided through various IDs defined through the mapping system, to enable adaptation of host-based ID/LOC separation to a cloud computing environment established through a large-scale datacenter.

### CROSS-REFERENCE TO RELATED APPLICATION

This application claims the priority benefit of Korean Patent Application No. 10-2012-0006498, filed on Jan. 20, 2012, in the Korean Intellectual Property Office, the disclosure of which is incorporated herein by reference.

### BACKGROUND

1. Field of the Invention

The present invention relates to a mapping system for a mapping structure between various identifiers (IDs), each ID defined for a layer providing a new abstraction, to enable adaptation of ID/locator (LOC) separation to a large-scale datacenter for cloud computing by expanding the ID/locator (LOC) separation used as an essential element of a future Internet network infrastructure.

2. Description of the Related Art

A current Internet architecture fails to support multihoming and mobility due to overlapping uses of an identifier (ID) and a locator (LOC) of an Internet Protocol (IP) address. By way of this overlapping IP address structure, such as a patch solution, various technologies have been developed to support multihoming and mobility. However, an issue on routing scalability is raised. Accordingly, a demand for a new Internet architecture is increasing. Future Internet research aims to remodel a current Internet architecture in a clean-slate design to meet the requirements for multihoming, mobility, security, and the like, and is being conducted on various Internet architecture and services extensively. The Internet architecture research chiefly focuses on ID/LOC separation to handle IP address overlapping. To implement ID/LOC separation, ID/LOC mapping is necessary. Studies are being conducted on a global-scale mapping system for mapping between an identifier for a communication session and a dynamically changing locator.

Also, datacenter-based cloud computing is gaining attention in a current Internet architecture as well as a future Internet architecture. As it is expected that most Internet traffic will be mainly used for multimedia, development is directed toward network storage and sharing of data rather than hosting storage and sharing of data, for example, a peer-to-peer (P2P) scheme. Accordingly, cloud computing is changing the Internet, for example, allocation of a virtual machine (VM) suitable for a service to datacenters distributed on large scale over a wide range of different areas using a virtualization platform.

Currently, private and public clouds are being built separately, and under the assumption that this trend increases, it is predicted that data traffic may mostly occur between datacenters constructed on large scale in the near future. However, for cloud communications, technologies and standards for interworking clouds are required. In particular, in a case of a VM allocating a virtual resource to a host, integrated VM management is needed. This is similar to a past situation leading to the creation of a common network, that is, the Internet.

Additionally, an issue associated with IP address allocation and networking occurring in datacenters constructed on large scale is present. A method of identifying a physical server in a datacenter is only an IP address that is also actually used for routing in the datacenter. Nonetheless, an identifier and a locator of an IP address are problematic to a datacenter. In particular, when datacenters constructed on large scale over a wide range of different areas are provided by one cloud provider, an IP address is an improper resource for building a cloud effectively. Internet Protocol version 4 (IPv4) has already been exhausted and is insufficient for providing a private IP address space, and to newly allocate IPv6, an issue in terms of policies or technologies, for example, a translation technology, is present.

Since prediction for a future Internet architecture is a data-centered communication structure and a datacenter-based cloud computing environment, to implement a large-scale cloud environment in an interworking manner, a cloud computing-based technology for federating and isolating existing datacenters for each service is needed. In particular, adaptation of an essential element, for example, ID/LOC separation to this technology is required.

### SUMMARY

An aspect of the present invention provides a mapping system, a network, and a method for adaptation of identifier (ID)/locator (LOC) separation to a cloud datacenter.

Another aspect of the present invention also provides a structure and control method for an ID/LOC mapping system, in which a cloud datacenter environment may be divided into layers hierarchically for adaptation to ID/LOC separation, an ID may be defined for each layer, and a networking service may be provided through various defined IDs, to enable adaptation of host-based ID/LOC separation to a cloud computing environment established through a large-scale datacenter.

According to an aspect of the present invention, there is provided a mapping system for ID/LOC separation including an ID database to store a cloud ID (CID), a datacenter ID (DCID), and a physical server ID (PSID) corresponding to each virtual machine (VM) ID, a receiving unit to receive a search request message including the VMID and to identify a transmission device transmitting the search request message, a mapping unit to search for a next layer ID corresponding to a next layer of the transmission device transmitting the search request message, using the ID database, and a transmitting unit to generate a search response message including the next layer ID and to transmit the search response message to the transmission device transmitting the search request message.

According to another aspect of the present invention, there is provided a network for ID/LOC separation including a domain name system (DNS) server to provide a VMID of a target device, a host to identify the VMID of the target device through the DNS server and to transmit data including the VMID to a host access router (HAR), a mapping system to search for, when a search request message including the VMID is received, a next layer ID corresponding to a next layer of a transmission device transmitting the search request message, and to transmit a search response message including the next layer ID to the transmission device transmitting the search request message, an HAR to identify, when the data including the VMID is received, a CID through the mapping system and to transmit the data including the VMID to a cloud access router (CAR) corresponding to the CID, and a CAR to identify, when the data including the VMID is received, a PSID through the mapping system and to transmit the data including the VMID to a physical server corresponding to the PSID.

According to still another aspect of the present invention, there is provided a method for ID/LOC separation using a mapping system, the method including receiving a search request message including a VMID, identifying a transmission device transmitting the search request message, searching for a next layer ID corresponding to a next layer of the transmission device transmitting the search request message, and generating a search response message including the next layer ID and transmitting the search response message to the transmission device transmitting the search request message.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a structure in which identifier (ID)/locator (LOC) separation is adapted to a cloud datacenter according to an embodiment of the present invention;

FIG. 2 is a diagram illustrating data transmission from a host to a cloud virtual machine (VM) according to an embodiment of the present invention;

FIG. 3 is a diagram illustrating data transmission between cloud virtual machines (VMs) according to an embodiment of the present invention;

FIG. 4 is a diagram illustrating a hierarchical structure according to an embodiment of the present invention;

FIG. 5 is a block diagram illustrating a configuration of a mapping system according to an embodiment of the present invention; and

FIG. 6 is a flowchart illustrating a process of searching for and providing a next layer ID in a mapping system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

The present invention proposes a networking architecture and procedure for adaptation to a large-scale cloud datacenter network by expanding host-based identifier (ID)/locator (LOC) separation and a mapping system for mapping between a host ID (HID) and a locator, to provide an effective cloud environment and a scalable, flexible, and fault-tolerant inter-cloud communication for various cloud computing in the future.

According to the present invention, from a perspective of a datacenter for cloud computing, various IDs used in ID/LOC separation may be processed due to a hierarchical ID structure and expansion of a mapping system. In particular, a cloud datacenter-based ID/LOC mapping system may enable identification of a final physical location through IDs of various layers, differently from a host-based ID/LOC mapping system for simple ID/LOC mapping.

Generally, for a user or device to be provided with a cloud computing service, additional authentication for user identification, security, billing, and rights administration is needed. The user identification in cloud computing is well known and thus, a description is omitted herein for conciseness.

In a cloud computing service, infrastructure as a service (IaaS) is considered to be the most basic cloud service model in which a cloud computing provider offers a virtual machine (VM) to a corresponding user. The VM is run as a terminal such as, for example, a user or device, and needs a VM ID such as, for example, a HID. The relevance between the VM ID and the HID may be processed during ID allocation by a domain name system (DNS) server.

When a VM ID uses a common space of cloud computing environments provided by various cloud computing providers, mapping is required to identify a cloud computing provider from which the VM ID actually comes. Also, a cloud ID (CID) for identifying a cloud is needed. That is, interworking between clouds may be supported through a mapping structure.

Since datacenters are distributed on large scale over a wide range of different areas in one cloud computing environment established by one cloud computing provider, a CID needs a datacenter ID (DCID) to identify a datacenter from which a cloud is allocated, and mapping between the CID and the DCID is needed.

Also, a DCID needs to be mapped to a physical server to process data for actual communication. Accordingly, a physical server ID (PSID) and mapping between the DCID and the PSID are needed.

As described in the foregoing, a new abstraction for a cloud datacenter and definition of an ID for each abstraction are needed.

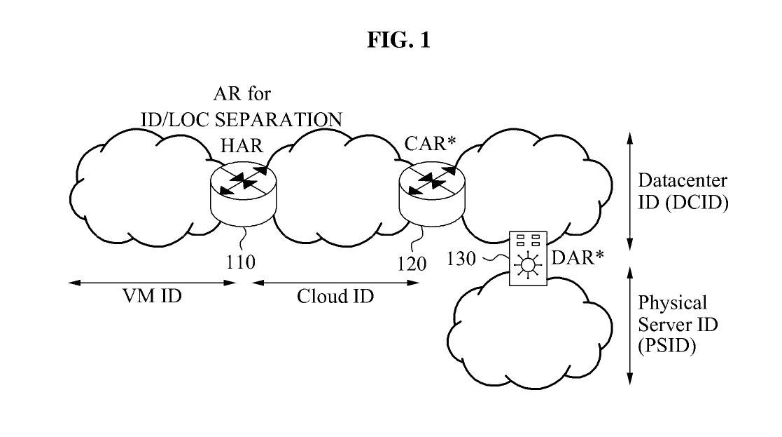

The present invention proposes a network architecture for cloud computing that may be divided into two layers, and the network architecture and definition of an ID for each layer is shown in FIG. 1.

FIG. 1 is a diagram illustrating a structure in which ID/LOC separation is adapted to a cloud datacenter according to an embodiment of the present invention.

A host access router (HAR) 110 may be generally present to separate a domain working by a HID from a domain working by a locator for ID/LOC separation in a host-based Internet. In the present invention, the HAR 110 may recognize a VMID to be an identifier for cloud computing.

Also, the present invention proposes two additional ARs for cloud computing. One may correspond to a cloud AR (CAR) 120 to separate a cloud domain for interworking between various cloud computing services. The CAR 120 may use a CID to identify a cloud domain functionally, and the CID may correspond to an identifier of the CAR 120 and may be recognized to be a locator on a routing locator domain. That is, the CID may be used for routing to the corresponding CAR 120 in a similar manner to a locator of host-based communication.

The other may correspond to a datacenter AR (DAR) 130 to separate a datacenter domain for interworking between datacenters. The DAR 130 may use a DCID to identify a corresponding datacenter in a cloud domain, and the DCID may correspond to an identifier of the DAR 130 and may be recognized to be a locator on a cloud domain to transmit data to the corresponding DAR 130.

That is, in a different manner from conventional host-based ID/LOC separation, ID/LOC separation having two additional layers according to the present invention may include the HAR 110, the CAR 120, and the DAR 130. The CAR 120 and the DAR 130 may transmit data on a corresponding domain by converting a VMID into CID and CID into a DCID and a PSID, respectively.

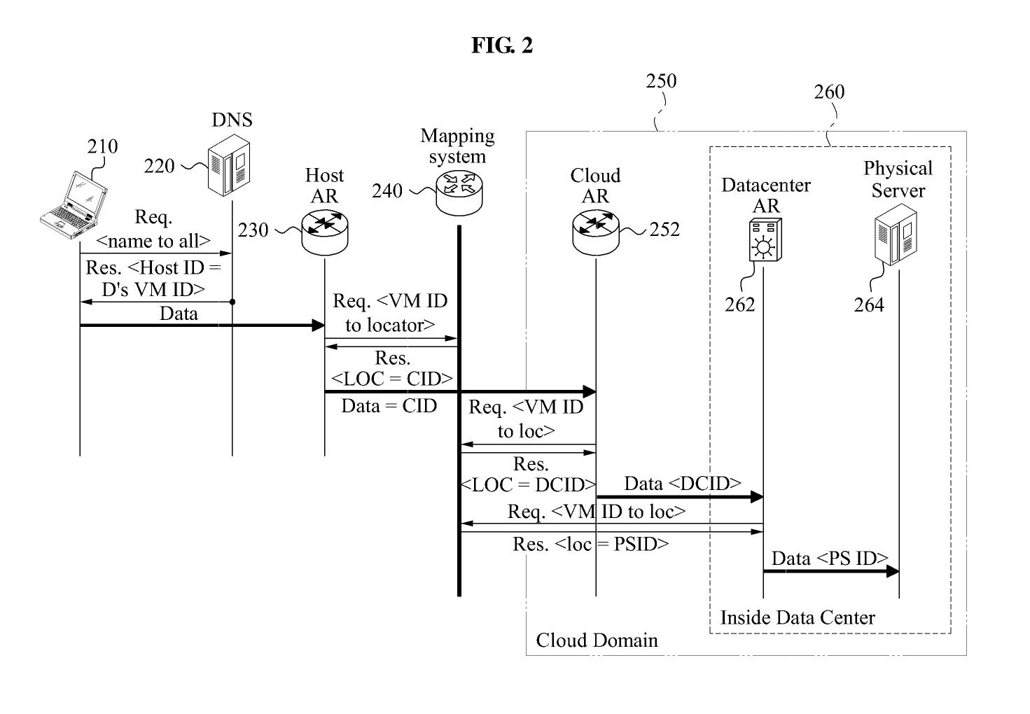

FIG. 2 is a diagram illustrating data transmission from a host to a cloud VM according to an embodiment of the present invention.

Referring to FIG. 2, the host 210 may request a VMID of a target device from a DNS server 220 and may identify the VMID. In this instance, the host 210 may request the VMID of the target device by transmitting a uniform resource locator (URL) of the target device to the DNS server 220.

When the host 210 identifies the VMID of the target device, the host 210 may transmit data including the VMID to an HAR 230.

When the HAR 230 receives the data including the VMID from the host 210, the HAR 230 may identify a CID through a mapping system 240 and may transmit the data including the VMID to a CAR 252 of a cloud domain 250 corresponding to the CID.

In this instance, when the mapping system 240 receives a search request message including the VM ID, the mapping system 240 may search for a next layer ID corresponding to a next layer of a device transmitting the search request message, and may transmit a search response message including the next layer ID to the device transmitting the search request message.

When the CAR 252 receives the data including the VMID from the HAR 230, in a case in which a plurality of DARs is present, the CAR 252 may identify a DCID through the mapping system 240 and may transmit the data including the VMID to a DAR 262 of a datacenter domain 260 corresponding to the DCID.

When the DAR 262 receives the data including the VMID from the CAR 252, the DAR 262 may identify a PSID through the mapping system 240 and may transmit the data including the VMID to a physical server 264 corresponding to the PSID.

In this instance, in a case in which the DAR 262 is absent, that is, when the DAR 262 is identical to the physical server 264, when the CAR 252 receives the data including the VMID from the HAR 230, the CAR 252 may identify a PSID through the mapping system 240 and may transmit the data including the VMID to the physical server 264 corresponding to the PSID.

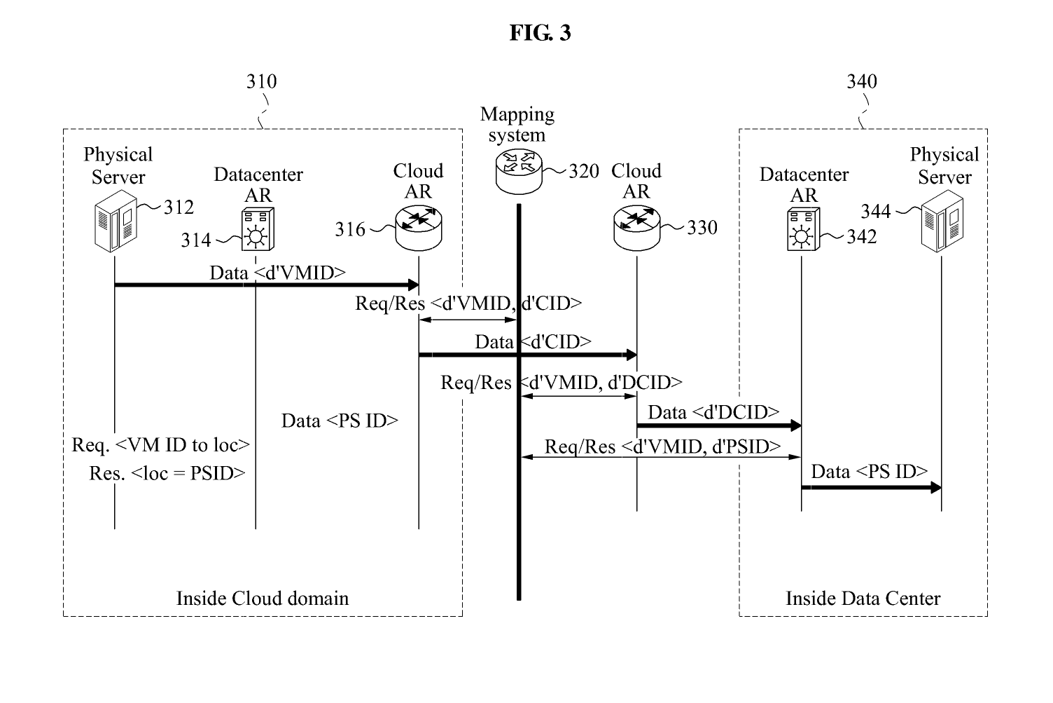

FIG. 3 is a diagram illustrating data transmission between cloud VMs according to an embodiment of the present invention.

Referring to FIG. 3, a source-side physical server 312 may transmit data including a target-side VMID to a CAR 316 of a cloud domain 310 without passing through a DAR 314.

When the source-side CAR 316 receives the data including the VMID from the source-side physical server 312, the source-side CAR 316 may identify a CID through a mapping system 320 and may transmit the data including the VMID to a target-side CAR 330 corresponding to the cloud ID.

In this instance, when the mapping system 320 receives a search request message including the VM ID, the mapping system 240 may search for a next layer ID corresponding to a next layer of a device transmitting the search request message, and may transmit a search response message including the next layer ID to the device transmitting the search request message.

When the target-side CAR 330 receives the data including the VMID from the source-side CAR 316, the target-side CAR 330 may identify a DCID through the mapping system 320 and may transmit the data including the VMID to a DAR 342 of a datacenter domain 340 corresponding to the DCID.

When the DAR 342 receives the data including the VMID from the CAR 330, the DAR 342 may identify a PSID through the mapping system 320 and may transmit the data including the VMID to a target-side physical server 344 corresponding to the physical server ID.

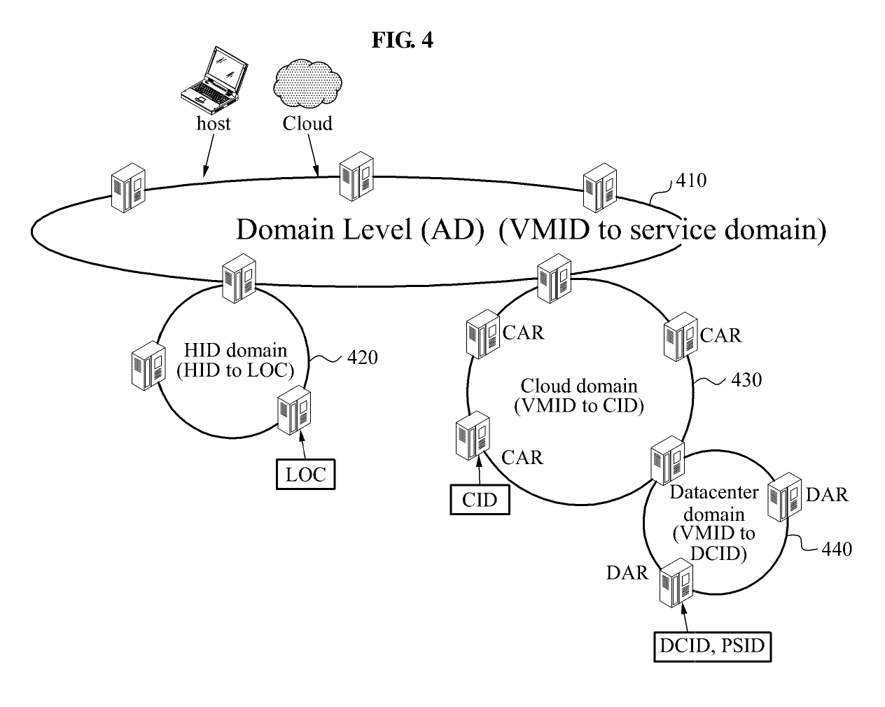

FIG. 4 is a diagram illustrating a hierarchical structure according to an embodiment of the present invention.

Referring to FIG. 4, the mapping system of the present invention may classify network devices into layers, and may implement each layer in a distributed hash table (DHT) ring design suitable for various environments.

The mapping system may be designed to ensure scalability for use with host-based ID/LOC separation, and to obtain a final ID, that is, a PSID, through a recursive structure.

The present invention may configure a VMID as a self-certifying ID, and to support general host-based communication, may build a separate administrative domain (AD).

The AD 410 may be built in a hierarchical DHT ring design as well as in a flat design, to enable adaptation of a VM to various dynamic environments, for example, mobility, and to ensure scalability and fault tolerance. In this instance, the AD 410 may be connected to an HID domain 420 or a cloud domain 430 in a hierarchical manner.

The mapping system may obtain additional information as well as information associated with the VM on the AD 410, and a VMID may be obtained through a DNS.

When the mapping system enters the cloud domain 430 using the VMID, the mapping system may search for a CID corresponding to the VM on various cloud domains 430. According to the present invention, the cloud domain 430 may be implemented in a hierarchical DHT ring design for a recursive structure.

On the cloud domain 430 corresponding to a second layer, the mapping system may search for a CID corresponding to the VMID through mapping. In this layer, the VMID may be used as a key and the CID may be used as a value to be searched for.

Similar to mapping in the second layer, on the datacenter domain 440 corresponding to a third layer, the mapping system may search for a DCID using the VMID through mapping. In this instance, when datacenters are constructed on large scale over a wide range of different areas on the datacenter domain 440 managed by one cloud provider, the mapping system may also search for a PSID corresponding to a physical server to identify a datacenter to which the VM belongs among the datacenters, using the VMID.

According to the present invention, the datacenter domain 440 may be built in a DHT ring design. On the datacenter domain 440, the mapping system may search for a physical server storing the corresponding DCID using the VMID, and a PSID may be obtained directly from the physical server.

As described in the foregoing, conventional host-based ID/LOC separation attempts ID/LOC separation using simple mapping, but the present invention proposes ID/LOC separation using additional mapping for two layers, in a cloud computing environment.

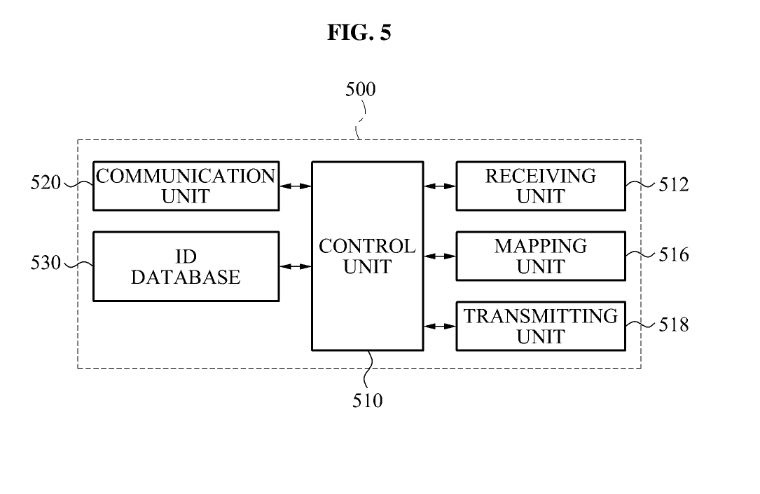

FIG. 5 is a block diagram illustrating a configuration of the mapping system according to an embodiment of the present invention.

Referring to FIG. 5, the mapping system 500 may include a control unit 510, a receiving unit 512, a mapping unit 516, a transmitting unit 518, a communication unit 520, and an ID database 530.

The communication unit 520 may communicate with hierarchical communication devices via an Internet. The communication unit 520 according to an embodiment of the present invention may receive a search request message and may transmit a search response message. Also, the communication unit 520 may maintain and manage route information for communication by transmitting and receiving control messages for a DHT.

The ID database 530 may store a CID, a DCID, and a PSID corresponding to each VM ID. That is, the ID database 530 may store information using a VMID as a key and a CID as a value, or using a CID as a key and a DCID and a PSID as a value, depending on a DHT domain.

The receiving unit 512 may receive a search request message including a VM ID, and may identify a transmission device transmitting the search request message.

The mapping unit 516 may search for a next layer ID corresponding to a next layer of the transmission device transmitting the search request message, using the ID database 530.

When the transmission device transmitting the search request message corresponds to an HAR, the mapping unit 516 may search for a CID to be used as the next layer ID.

When the transmission device transmitting the search request message corresponds to a CAR and a DCID to be used as the next layer ID is present, the mapping unit 516 may search for a DCID to be used as the next layer ID.

When the transmission device transmitting the search request message corresponds to a CAR and a DCID to be used as the next layer ID is absent, the mapping unit 516 may search for a PSID to be used as the next layer ID.

When the transmission device transmitting the search request message corresponds to a DAR, the mapping unit 516 may search for a PSID to be used as the next layer ID.

The mapping unit 516 may manage the VMID, the CID, the DCID, and the PSID of different layers integratedly.

The mapping unit 516 may implement each layer in a DHT ring design suitable for mobility and various environments.

The transmitting unit 518 may generate a search response message including the next layer ID and may transmit the search response message to the transmission device transmitting the search request message.

The control unit 510 may control the entire operation of the mapping system 500. Also, the control unit 510 may perform functions of the receiving unit 512, the mapping unit 516, and the transmitting unit 518. Although FIG. 5 shows the receiving unit 512, the mapping unit 516, and the transmitting unit 518 individually to describe the functions of the receiving unit 512, the mapping unit 516, and the transmitting unit 518 separately, the control unit 510 may include at least one processor configured to perform the function of each of the receiving unit 512, the mapping unit 516, and the transmitting unit 518. Also, the control unit 510 may include at least one processor configured to perform a portion of the function of each of the receiving unit 512, the mapping unit 516, and the transmitting unit 518.

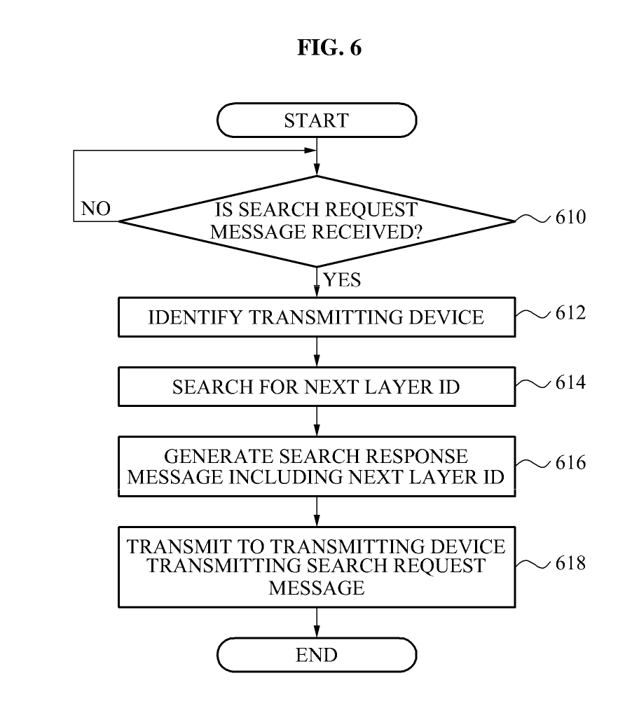

Hereinafter, a mapping method for adaptation of ID/LOC separation to the cloud datacenter according to the present invention is described with reference to FIG. 6.

FIG. 6 is a flowchart illustrating a process of searching for and providing a next layer ID in the mapping system according to an embodiment of the present invention.

Referring to FIG. 6, the mapping system may verify whether a search request message including a VMID is received, in operation 610.

When it is verified that the search request message is received in operation 610, the mapping system may identify a transmission device transmitting the search request message in operation 612.

In operation 614, the mapping system may search for a next layer ID corresponding to a next layer of the transmission device transmitting the search request message.

In operation 616, the mapping system may generate a search response message including the next layer ID. In this instance, when the transmission device transmitting the search request message corresponds to an HAR, the mapping system may transmit the search response message including the next layer ID to the HAR in operation 616. When the transmission device transmitting the search request message corresponds to a CAR and a DCID to be used as the next layer ID is present, the mapping system may transmit the search response message including the DCID to the CAR in operation 616. When the transmission device transmitting the search request message corresponds to a CAR and a DCID to be used as the next layer ID is absent, the mapping system may transmit the search response message including a PSID to a CAR in operation 616. When the transmission device transmitting the search request message corresponds to a DAR, the mapping system may transmit the search response message including a PSID to the DAR in operation 616.

In operation 618, the mapping system may transmit the generated search response message to the transmission device transmitting the search request message.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard discs, floppy discs, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

The present invention may provide a mapping system, a network, and a method for adaptation of ID/LOC separation, in particular, hierarchical ID/LOC separation to a cloud datacenter, to establish a scalable, flexible, and fault-tolerant cloud computing network environment and to support an effective and flexible network service through a mapping system designed to be able to make a recursive structure.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A mapping system for identifier (ID)/locator (LOC) separation comprising:
an ID database to store a cloud ID (CID), a datacenter ID (DCID), and a physical server ID (PSID) corresponding to each virtual machine (VM) ID;
a receiving unit to receive a search request message including the VMID and to identify a transmission device transmitting the search request message;
a mapping unit to search for a next layer ID corresponding to a next layer of the transmission device transmitting the search request message, using the ID database; and
a transmitting unit to generate a search response message including the next layer ID and to transmit the search response message to the transmission device transmitting the search request message.

2. The mapping system of claim 1, wherein the mapping unit searches for the CID to be used as the next layer ID when the transmission device transmitting the search request message corresponds to a host access router (HAR).

3. The mapping system of claim 1, wherein the mapping unit searches for the DCID to be used as the next layer ID when the transmission device transmitting the search request message corresponds to a cloud access router (CAR) and the DCID to be used as the next layer ID is present.

4. The mapping system of claim 1, wherein the mapping unit searches for the PSID to be used as the next layer ID when the transmission device transmitting the search request message corresponds to a CAR and the DCID to be used as the next layer ID is absent.

5. The mapping system of claim 1, wherein the mapping unit searches for the PSID to be used as the next layer ID when the transmission device transmitting the search request message corresponds to a datacenter access router (DAR).

6. The mapping system of claim 1, wherein the mapping unit manages the VMID, the CID, the DCID, and the PSID of different layers integratedly.

7. The mapping system of claim 1, wherein the mapping unit implements each layer in a distributed hash table (DHT) ring design suitable for mobility and various environments.

8. A network for identifier (ID)/locator (LOC) separation comprising:
a domain name system (DNS) server to provide a virtual machine (VM) ID of a target device;
a host to identify the VMID of the target device through the DNS server and to transmit data including the VMID to a host access router (HAR);
a mapping system to search for, when a search request message including the VMID is received, a next layer ID corresponding to a next layer of a transmission device transmitting the search request message, and to transmit a search response message including the next layer ID to the transmission device transmitting the search request message;
an HAR to identify, when the data including the VMID is received, a cloud ID (CID) through the mapping system and to transmit the data including the VMID to a cloud access router (CAR) corresponding to the CID; and
a CAR to identify, when the data including the VMID is received, a physical server ID (PSID) through the mapping system and to transmit the data including the VMID to a physical server corresponding to the PSID.

9. The network of claim 8, further comprising:
a DAR to identify, when the data including the VMID is received, a physical server ID (PSID) corresponding to the PSID through the mapping system and to transmit the data including the VMID to a physical server corresponding to the PSID,
wherein the CAR identifies, when a plurality of datacenter access routers (DARs) is present, a datacenter ID (DCID) through the mapping system and to transmit the data including the VMID to a DAR corresponding to the DCID.

10. The network of claim 8, wherein the mapping system comprises at least one of the CID, the DCID, and the PSID corresponding to each VMID,
when the transmission device transmitting the search request message corresponds to the HAR, the mapping system transmits the search response message including the CID to the HAR,
when the transmission device transmitting the search request message corresponds to the CAR and the DCID to be used as the next layer ID is present, the mapping system transmits the search response message including the DCID to the CAR,
when the transmission device transmitting the search request message corresponds to the CAR and the DCID to be used as the next layer ID is absent, the mapping system transmits the search response message including the PSID to the CAR, and
when the transmission device transmitting the search request message corresponds to the DAR, the mapping system transmits the search response message including the PSID to the DAR.

11. A method for identifier (ID)/locator (LOC) separation using a mapping system, the method comprising:
receiving a search request message including a virtual machine (VM) ID;
identifying a transmission device transmitting the search request message;
searching for a next layer ID corresponding to a next layer of the transmission device transmitting the search request message; and
generating a search response message including the next layer ID and transmitting the search response message to the transmission device transmitting the search request message.

12. The method of claim 11, wherein the searching for of the next layer ID comprises searching for a cloud ID (CID) to be used as the next layer ID when the transmission device transmitting the search request message corresponds to a host access router (HAR).

13. The method of claim 11, wherein the searching for of the next layer ID comprises searching for a datacenter ID (DCID) to be used as the next layer ID when the transmission device transmitting the search request message corresponds to a cloud access router (CAR) and the DCID to be used as the next layer ID is present.

14. The method of claim 11, wherein the searching for of the next layer ID comprises searching for a physical server ID (PSID) as the next layer ID when the transmission device transmitting the search request message corresponds to a CAR and the DCID to be used as the next layer ID is absent.

15. The method of claim 11, wherein the searching for of the next layer ID comprises searching for a PSID to be used as the next layer ID when the transmission device transmitting the search request message corresponds to a datacenter access router (DAR).

16. The method of claim 11, wherein the searching for of the next layer ID comprises managing the VMID, the CID, the DCID, and the PSID of different layers integratedly.

17. The method of claim 11, further comprising:
implementing, in advance of receiving the search request message, each layer in a distributed hash table (DHT) ring design suitable for mobility and various environments.
